(19) United States
(12) Patent Application Publication
(10) Pub. No.: US 2006/0119787 A1
(43) Pub. Date: Jun. 8, 2006

(54) Sunglass clip-on

(76) Inventor: Wen Jie Dai, Hong Kong (HK)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/006,565

(22) Filed: Dec. 8, 2004

(51) Int. Cl. G02C 9/00

(52) U.S. Cl. 351/47

(57) ABSTRACT

A sunglass clip-on includes an eyeglass-covering portion from which a pair of legs extend rearwardly. Each leg includes a generally horizontal segment and a downward segment. A head is carried by the downward segment of each leg and each head includes a magnetic coupling part having a forwardly facing surface magnetically attachable to a rearwardly facing surface of a magnetic coupling, art affixed to an eyeglass frame at a location remote from an adjustable bridge of the eyeglasses

### TECHNICAL AREA

This invention relates generally to eyeglasses, and in particular to clip-on sunglasses.

### TECHNICAL BACKGROUND

Clip-on sunglasses have been found on the market long ago. People walking in the sunlight with these sunglasses can protect their eyes well, so it is welcomed by customers very much. One of the types of clip-ons that can be found is magnetic clip-ons. The magnetic connection point between the frame and the clip-on is at the end of the arms of the bridge on the frame. Although it is convenient to attach or separate the clip-on, owing to the resistance generated from the magnets, adjusting the bridge is difficult and will make users uncomfortable, and makes it harder to adjust the glasses as well.

The purpose of this invention is to provide a magnetic sunglass clip-on which is convenient to be clipped onto and taken off from the eyeglass frame, while making it easy to adjust the position of the bridge on the frame, so that users will find it comfortable and convenient.

### SUMMARY OF THE INVENTION

The technological solution proposal of this invention involves fixing first magnetic coupling parts on the ends of two rearwardly projecting legs of the clip-on and providing two second magnetic coupling parts on the eyeglass rim, whereby forwardly facing surfaces of the first parts magnetically engage rearwardly facing surfaces of the second parts.

The coupling parts can be circular in shape, oval in shape, square in shape or in other shapes.

The contacting surfaces of the coupling parts are plane, or concave on one part and convex on the other part or in other shapes.

The coupling parts on the eyeglass frame are fixed by being connected to the ends of the arms or by partly overlapping with them.

Each leg of the clip-on has a head disposed on a free end thereof, with a magnetic coupling part embedded in the head.

The Working Theory: when the clip-on is put onto the frame, the magnetic coupling parts firmly adhere to one another. When taking off the clip-ons, only a little force is needed to overcome the magnetism, and the clip-ons can be taken off conveniently. Furthermore, the contact points of the magnets are remote from the free ends of the bridge-carrying arms, i.e., especially higher than such ends and forwardly of such ends, so as to not affect the adjustment of the bridge.

The advantages of the new model: (i) it is easy to wear and take off the clip-ons and convenient to adjust the positions of the bridge. Hence, users will find it comfortable and convenient.

### THE DRAWINGS

The objects and advantages of the invention will become apparent from the following detailed description of a preferred embodiment thereof in connection with the accompanying drawing in which like numerals designate like elements, and in which:

FIG. 1 is a front view of prior art eyeglasses;

FIG. 2 is a side view of a sunglass clip-on according to the invention;

FIG. 3 is a side view of the eyeglasses of FIG. 1;

FIG. 4 depicts the sunglass clip-on attached to the eyeglasses.

FIG. 5 is a fragmentary sectional view through a sunglass clip-on attached to the frame of a slightly different style eyeglass; and

FIG. 6 is a rear view through the arrangement of FIG. 5.

### DETAILED DESCRIPTION OF A PREFERRED EMBODIMENT

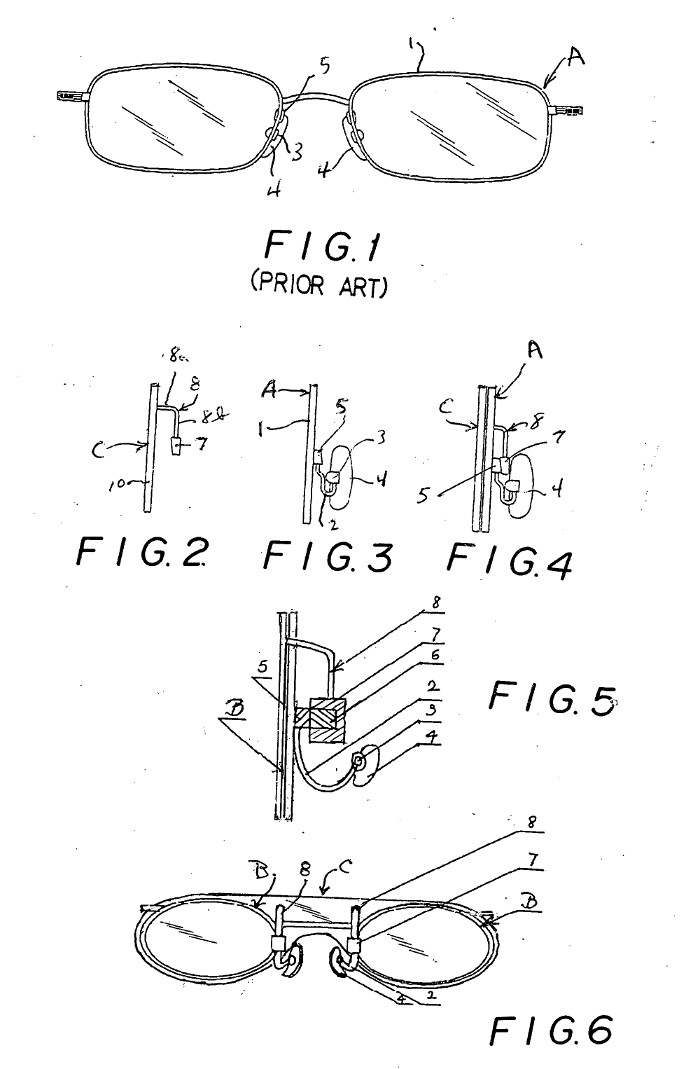

Depicted in FIGS. 1 and 3 are conventional eyeglasses A, the frame of which includes an eye rim 1 having a pair of rearwardly projecting arms 2. A swivel 3 is disposed at the free end of each arm 2, and an adjustable nose bridge 4 is attached to each swivel.

The sunglass clip-on C shown in FIG. 2 comprises a tinted glass or plastic eyeglass-covering portion 10, a pair of legs 8 each including a generally horizontal segment 8a projecting from the eyeglass covering portion, and a downwardly extending segment 8b which carries a head 7. Each head 7 carries a first magnetic coupling part 6 which is adapted to be magnetically coupled to a second magnetic coupling part 5 affixed to the rim 1 and from which a respective arm 2 extends (see FIG. 5). Alternatively the part 5 could be next to the arm 2. The first coupling part 6 could comprise a strong magnet and the second part 5 a magnetizable material (e.g., a suitable metal), or vice versa. Alternatively, both parts 6, 5 could comprise strong magnets. The first part 6 has a forwardly facing surface 6a which contacts a rearwardly facing surface 5a of the second part.

The head 7 is preferably rectangular shape, but other shapes could be employed.

FIG. 5 depicts eyeglasses B that differ from the eyeglasses A in that the arms 2 of the eyeglasses B are generally calumet shaped, and the eye rim is oval instead of rectangular.

What is claimed is:

1. A sunglass clip-on comprising:
a tinted eyeglass-covering portion;
a pair of legs extending rearwardly from the eyeglass-covering portion, each leg including a generally horizontal segment and a generally downward segment; and
a head carried at a free end of the downward segment of each arm, each head including a magnetic coupling part having a forwardly facing contact surface.

2. The clip-on according to claim 1 wherein the forwardly facing surface is planar.

3. The clip-on according to claim 1 wherein the magnetic coupling part is encased within the respective head.

4. In combination:
eyeglasses including a rim, two arms extending rearwardly from the rim, a bridge attached at a free end of each arm, and a pair of second magnetic coupling parts fixed on the frame adjacent forward ends of respective arms, each second magnetic coupling part having a rearwardly facing contact surface; and
a sunglass clip-on comprising:
a tinted eyeglass-covering portion,
a pair of legs extending rearwardly from the eyeglass-covering portion, each leg including a generally horizontal segment and a generally downwardly extending segment, and
heads carried by the downwardly extending segment of respective legs, each head carrying a second magnetic coupling part having a forwardly facing contact surface attached magnetically to a respective rearwardly facing contact surface.

5. The combination according to claim 4 wherein the forwardly facing surfaces and the rearwardly facing surfaces are planar.

6. The combination according to claim 4 wherein the magnet is encased within a respective head.

7. The combination according to claim 4 wherein the first magnetic coupling parts comprise permanent magnets, and the second magnetic coupling parts comprise magnetizable material.

8. The combination according to claim 4 wherein the first magnetic coupling parts comprise magnetizable material, and the second magnetic coupling parts comprise permanent magnets.

9. The combination according to claim 4 wherein the first and second magnetic coupling parts comprise permanent magnets.

10. The combination according to claim 4 wherein the second magnetic coupling parts are located higher than, and forwardly of, rearward ends of the arms.

11. The combination according to claim 4 wherein the arms project from respective second magnetic coupling parts.
